(19) United States
(12) Patent Application Publication
(10) Pub. No.: US 2002/0021900 A1
(43) Pub. Date: Feb. 21, 2002

(54) Leader card for a photographic film and devices for attaching and detaching said card to a photographic film

(75) Inventors: Danny Lant, Basiliano fraz. Villa Orba (IT); Eni Scodellaro, Cordenos (IT)

Correspondence Address: Dike, Bronstein, Roberts & Cushman, Intellectual Property Practice Group, Edwards & Angell, LLP, 130 Water Street, Boston, MA, 02109, US

(73) Assignee: San Marco Imaging Sr1

(21) Appl. No.: 09/908,313

(22) Filed: Jul. 17, 2001

(30) Foreign Application Priority Data
Jul. 17, 2000 (EP) 00 114 920.2

(51) Int. Cl. G03B 1/00; G03D 13/08

(52) U.S. Cl. 396/387; 396/415; 396/647

(57) ABSTRACT

The present invention relates to a leader card with protrusions, which are extended in the counter direction with respect to the transport direction of the leader card with the film attached thereto, said protrusions being provided with traction sections which can be brought into engagement with holes in the leading end of the film. Additionally, the invention relates to an attaching and a detaching device to attach and to detach, respectively, the leader card to and from the film.

### FIELD OF THE INVENTION

The present invention relates generally to the field of photo finishing and in particular to a leader card for the traction of the photographic film which has to be attached thereto, said leader card having a coupling cut-out at the trailing end thereof for coupling said photographic film thereto. Additionally, the present invention relates to a device for attaching the leader card to the photographic film and to a detaching device for detaching the leader card from said photographic film.

### BACKGROUND OF THE INVENTION

In the past few years many attempts have been started to promote the automization of the photo finishing process also for the field of minilabs. In the field of minilabs, one photographic film, which has been exposed, is supplied to the entrance of the minilab in that the film, which is in a cartridge, is connected to the minilab entrance. The cartridge and minilab entrance are light proof or light tide and the film then has to be drawn into the minilab. However, since the film can be damaged and is difficult to transport through the development compartment in a minilab without being treated unequally, it is usual to attach the film to a leader card, which usually has to be done at least partially manually.

One leader card has been disclosed in U.S. Pat. No. 4,110,774 which is provided with a tongue, and is inserted through an aperture in one end of the film. This kind of leader card operates, in principle, like a belt buckle.

In U.S. Pat. No. 5,339,130 a method of handling a film strip is disclosed. Owing to this method, a leader card is cut away from the leading end of a film and the film is coiled up.

U.S. Pat. No. 5,376,986 discloses an apparatus which operates to automatically remove a leader card from a film. The leader card includes a hole and from this hole a slit is extended to one edge of the leader card. The side parts or of labs of the leader card can be brought into engagement with a pair of holes in the leading end of the film.

U.S. Pat. No. 5,381,204 reveals a leader card which has at least one hook and a tap portion. The hook is formed to engage with at least one hole in the leading end of the film. The tap does not allow that the hook is removed from the corresponding aperture in the film.

U.S. Pat. No. 5,463,441 reveals a leader card which is provided with a pawl projecting from the surface of the leader body. The pawl has a tip which is inclined in a direction in which the leader is to be supplied. A pressing plate is located such that the film end, which is fixed to the leader card, is positioned between the leader and the pressing plate. EP 0 624 822 corresponds to this US patent.

U.S. Pat. No. 5,781,812 refers to a film cutting device. This cutting device connects a leader sheet with a coupler tongue, which extends across from a slot provided in the leader sheet. The tongue is supported by the opposite edge of the front slot.

U.S. Pat. No. 5,652,941 discloses a leader card, which includes a plurality of protrusions extending across a first film insertion hole. The protrusions are supported at an edge portion of the first film insertion hole. EP 0 738 923 A1 corresponds to this US patent.

U.S. Pat. No. 5,475,463 discloses a leader card with a cut-out and an engaging tap, which is extended in the feed direction in the leader card and the film itself. Several other embodiments disclosed in this US patent are comparable with this described embodiment. EP 0 618 498 A1 corresponds to this US patent.

U.S. Pat. No. 5,779,185 refers to a film splicing device for a leader card, which can be used to attach the leader to a film. The leader includes protrusions extending across one aperture in the leader card. Also these protrusions are extended in the direction of the film movement.

The above discussed prior art has in common the problem that the attachment of film to a leader card and the detachment of the film from the leader card do not function reliably. Therefore, in many cases, it is necessary to repeat the process attaching and detaching the leader card to and from the film, respectively. Very often it is necessary to do the attaching and detaching operations by hand.

### SUMMARY OF THE INVENTION

It is an object of the present invention to overcome the above-mentioned shortcomings of the prior art at least partially.

In particular it is an object of the present invention to provide a leader card which can be reliably attached and detached to and from a film, respectively.

It is another object of the invention to propose an attaching device as well as a detaching device for attaching or detaching a film to and from a leader card, respectively.

In brief, the above objects are solved by a leader card for the attachment to a leading end of a photographic film comprising a plane leader card body having several traction holes located along the longitudinal sides in transport direction of said leader card and of the film attached thereto, said leader card having a cut-out at the trailing end thereof and at least one protrusion to be brought into connection with the at least one aperture in the leading end of the film, wherein at least two protrusions are arranged at the leading end of the cut-out, said protrusions being extended in the counter direction with respect to the transport direction, wherein each of said protrusions are provided with a traction section to overlap with an edge of the aperture formed in the leading end of the film, each of said protrusions being deformable and/or deflectable.

The advantages of the present invention are based on the fact that the leader card according to the invention includes at least two protrusions which are arranged at the leading end of the cut-out, said protrusions being extended in the counter direction with respect to the transport direction of the film and the leader card itself. Each of the protrusions is provided with a traction section which can overlap with an edge of a hole which is formed in the leading end of the photographical film. The protrusions are deflectable in the counter direction to the direction in which its corresponding traction section is protruding from said associated protrusion. Accordingly, it is possible to deflect or deform the protrusions so that the traction section can be brought out of engagement with the edge of a hole formed in the leading end for the photographical film to be detached. On the other hand, it is possible to deform or deflect the protrusion to introduce the traction section into the hole. Afterwards, when the protrusion is no longer deformed or deflected, the protrusion reinstitutes its original shape so that the traction section overlaps with an edge of the hole formed in the leading end of the photographical film so that the film is then hooked to the leader card. The traction sections are formed in the plane of the leader card body.

A very important aspect of this invention is that the protrusions with the traction sections are extended in the counter direction to the transport direction of the leader card and the film, while the prior art refers to protrusions which are extended in the direction of the film transport. Accordingly, the mechanical load of the film has the positive effect of strengthening the connection between the traction section of the protrusions and the film. Any movements of the film itself in the transport direction, which are not synchronous to the movement of the leader card are not able to weaken the connection, since the leading film end cannot be lifted over the protrusions as is possible according to the prior art. On the other hand, to connect or disconnect, i.e. attach or detach, the film to, from the leader card, it is necessary to act on the protrusion such that these protrusions and/or their corresponding traction sections are deflected or deformed such that it is possible to introduce the traction sections through the holes or openings in the leading end of the photographic film.

While it is possible to form the protrusions with the traction sections in a cut-out at the trailing end of the leader card, it is preferable to provide a cutting hole in the trailing end of the leader card and to form the protrusions with the traction sections in this coupling hole. This embodiment is preferred since it is possible to secure the connection area of the film and the leader card, because the film is not able to be bent in all directions with respect to the protrusions. This means that it is possible to avoid accidental deformation of the protrusions with the traction sections i.e. the connection can not be weakened.

Additional advantages can be achieved if an insertion hole, for inserting the leading end of the photographic film, is formed between the trailing end of the leader card body and the coupling hole. The film can be led through this insertion hole to be submitted to the coupling hole to be attached to the protrusions. The insertion hole prevents the film from being deformed with respect to the leader card such that the film can be detached from the leader card in any case, e.g. of discontinuity in the movement of the leader card on the film or both, sharp curves of the conveyor path in the minilab or the like. Accordingly, the insertion hole makes the connection between the leader card and the film more secure.

It is advantageous to form the protrusions in a leg shaped manner, such that the protrusions have a more rigid leg section and one spring section, which can be deformed in the reversible manner so that for the attaching operation, as well as for the detaching operation, the protrusions can be bent, rotated or the like so that the traction sections can be introduced or withdrawn, respectively, from the apertures or holes in the leading end of the film.

It has to be noted that, of course, it is also possible to only form one aperture or hole in the leading end of the film and to use only two protrusions, each having a traction. On the other hand, the connection between the film and the leader card can be made more secure, if two holes are formed in the leading end of the film, for instance by punching said holes, and by introducing at least one protrusion in each of the two holes.

To provide the spring sections for the protrusions, it is preferable to space said protrusions apart from each other, at least at their leading ends, which are connected to the leader card body at one edge of the coupling hole or the cut-out, respectively. It is preferable that the protrusions are formed such that their trailing ends are close together. This is because the parts of the protrusions having the traction sections can then provide support sections in the plane of the leader card body and those support sections can help to avoid a deformation of the protrusions during the conveyance of the film and the leader card according to the invention in the minilab.

It is preferred that said traction sections are at least roughly arrow-shaped, harpon-shaped or the like. This shape is helpful for introducing the traction section into the hole or aperture at a leading end of the film, on the one hand, and, on the other hand, the shoulder portion of this kind of shape is able to provide a safe mechanical connection between the edge of the hole or aperture in the film end and the leader card.

Accordingly, it is preferable to form two protrusions each to form an arrow-shaped traction section at their trailing ends. Both protrusions together then form the shape of an arrow with or without a tip, a rounded tip or the like.

Furthermore, in one advantageous embodiment according to the invention at least two pairs of protrusions are formed.

If the protrusions are provided with guiding means at their trailing ends, it is possible to faster the introduction of the traction sections into the holes or apertures at the leading end of the film by guiding the arrow-shaped tips of the protrusions with the traction sections along the guiding means e.g. an inclined surface, i.e. the arrow-shaped tips, a round surface or similar, makes way to be introduced into the hole or aperture at the leading end of the film, by sliding along the edge of said hole or aperture.

In summary, the leader card having features in accordance with the present invention allows for a reliable mechanical connection as well as for a reliable attaching and detaching operation.

In accordance with the present invention, an attaching device for connecting a leading end of a photographic film, having at least one hole, to a leader card according to the present invention includes a holding device for holding the leader card in a particular position, a transport device for transporting said film and/or said leader card in a transport direction and a deflecting means to deflect the protrusions of the leader card and/or the film end to guide the trailing ends of the protrusions with their traction sections into the hole or holes at the leading end of the photographic film. In contrast to the prior art, the attaching device according to the present invention does not use the film for deforming or deflecting the protrusions, but uses particular deflecting means to perform the attaching operation by deflecting or deforming the protrusions to be introduced in the holes or apertures at the leading end of the film.

To bend or deform the protrusions, the deflecting means are arranged such that the protrusions and/or films can be bent into an angle position with respect to the plane of the leader card body. In this angled position, it is possible to successfully introduce the traction section through the holes or apertures in the film end to connect the protrusions, i.e. the leader card, to the film end.

According to a further important embodiment of the invention, the holding device includes a base or top section having a track guide for the film. This track guide is used to guide the film in a position to be attached to the protrusions of the leader card. The track guide can also help to guide the film into the bent position in which it is inclined or angled with respect to the plane of the leader card body. In any case, the track guide is also helpful to introduce the film end into the insertion hole, if any is provided, before the film end is guided in the direction of the protrusions or the bent protrusions.

To widen the insertion hole or to support the orders of the insertion hole or to support the boarder and trailing end of the leader card, it is possible to provide a support die which can be lowered during the introducing operation to help to introduce the film end into the insertion hole.

According to another very useful embodiment, the holding device includes an advancing portion for deforming the leader card body in the vicinity of said insertion hole so that at least one of the leading edge and the trailing edge of the insertion hole of the leader card body is bent out of the plane of the leader card body so that the photographic film can be moved through the insertion hole by moving the film and/or the leader card.

Since many of the films will be exposed, but not developed, it will be important to locate an unloading compartment near the entrance for the film to be introduced into the attaching device. The compartment should be light proof or light tide. Of course, also the connection between the compartment and the attaching device must be light proof in case undeveloped films have to be introduced. The unloading compartment should be able to receive at least one film cartridge so that the film in the film cartridge can be unreeled to be introduced or drawn into the attaching device. To be able to work more effectively with the attaching device according to the invention, it is favorable if two or more unloading compartments are arranged such that photographic films may be alternatively supplied from them.

Another preferred embodiment comprises, first pressing means for pressing the protrusions in a direction such that the protrusions its traction sections can be introduced more easily in the holes in the leading end of the film.

According to a further preferred embodiment, the attaching device according to the invention includes a second pressing means for pressing the film in the direction towards the plane of the leader card body. This can help to force the traction sections and the corresponding parts of the protrusions into the apertures or holes in the leading end of the film.

According to a further aspect of the present invention, a detaching device is proposed for separating a photographic film from the leader card according to the present invention. This detaching device includes a detached holding means for holding the leader card and a detached transport device for transporting the leader card and/or the film, before, and/or after, the detaching operation. According to the invention, the detached deflecting means for deforming the protrusions of the leader card are provided such that the traction sections are released from the hole or holes in the leading end of the photographic film. The detached deflecting means are formed to catch the protrusions anywhere to bend, twist or deform the protrusions and/or said traction sections such that the traction sections can be withdrawn out of the hole or holes in the leading end of the film. Accordingly, the detached defecting means are preferably constructed such that the protrusions are deformed in the counter direction with respect to the extension direction of the traction section or sections.

According to another advantageous embodiment, the detached transport device of the detaching device is controlled to move the film and/or the leader card after the deformation of the protrusions such that the film is detached from said leader card. Accordingly, it is possible to separate the leader card from the film and to move these items away from each other.

According to another preferred embodiment, the detaching deflecting device includes injector means being ejectable into the plane of the leader card body, said ejector means having a forck-like shape with prongs being formed and/or movable such that the protrusions are deformed to release the film.

Arranged downstream of the detached deflecting means is a switch construction with two guide tracks connected thereto, one being for the transport of the film in particular to be coiled up in a film cartridge and the other being for the transport of the detached leader cartridge.

On the other hand, it is also possible to convey the separated film to an exposure device or a scanner device in order to process the film to create photographic prints.

Of course, the present invention is also related to a process for attaching a leader card to a film and to a process for detaching a film from a leader card.

### BRIEF DESCRIPTION OF THE DRAWINGS

In the following description, preferred embodiments according to all aspects of the invention are described with reference to the attached drawings. During the discussion of the drawings, further details, features, advantages and objectives of the invention are disclosed. In the drawings:

FIG. 1 shows in perspective view a first embodiment of a leader card;

FIG. 2 illustrates in plane view one section of the leader card according to FIG. 1;

FIG. 3 shows in plane view the protrusions according to FIG. 2 in a deformed situation;

FIG. 4 represents one embodiment of an attaching device in a first state in a functional longitudinal cross sectional view;

FIG. 5 illustrates in a longitudinal cross sectional view the embodiment of FIG. 4 in another state of operation;

FIG. 6 shows in a longitudinal cross sectional view the embodiment of FIGS. 4 and 5 in another functional state;

FIG. 7 illustrates in a longitudinal cross sectional view the embodiment of FIGS. 4 to 6 in another functional state of operation;

FIG. 8 represents another embodiment according to the third aspect of the invention, i.e. a detaching device in a perspective view;

FIG. 9 is a detached deflecting device in a front view;

FIG. 10 is a longitudinal cross sectional view of a further embodiment of a detaching device according to the present invention;

FIG. 10a is a principle view of the detaching means and the protrusions of FIG. 10 in a functional presentation;

FIG. 11 illustrates in a longitudinal cross sectional view the embodiments of FIGS. 10 and 10a in another functional state of operation;

FIG. 12 is another embodiment of a detaching device in accordance with the invention in a perspective view;

FIG. 12a shows in a longitudinal cross sectional view the embodiment of FIG. 12 in another functional state;

FIG. 13 is a principle view of another embodiment of a detaching device according to the invention;

FIG. 14 is the embodiment of FIG. 13 in a longitudinal cross section;

FIG. 15 illustrates a single detaching deflecting means in a longitudinal cross sectional view in operation;

FIG. 16 is a further attaching device in a principle longitudinal cross section;

FIG. 17 represents in a longitudinal cross sectional view a functional a functional presentation of the position of a film with respect to a leader card of the invention in the device of FIG. 16; and

FIG. 18 is a conveyor path through a photographic laboratory or minilab in the vicinity of a detaching device in a longitudinal cross sectional view.

### DETAILED DESCRIPTION OF THE DRAWINGS

In the drawings, identical items or those items which are at least identical in function are always referenced by means of the same reference number (or a reference number with “′”). Accordingly, if the same or basically the same, items are mentioned in reference to the figures, they are not necessarily explained and discussed once again if they were already explained or discussed earlier in this application.

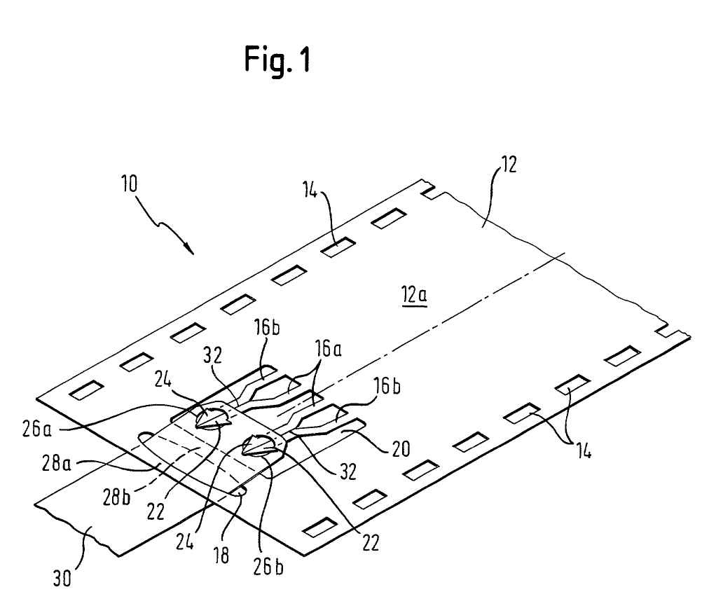

In FIG. 1, a leader card 12 in combination with a photographic film 30 are provided in a transport arrangement 10, which is used to convey a film through a developer compartment in a minilab.

The leader card 12 includes some holes 14 along its lateral edges. These holes are used to convey the leader card together with a film by means of the traction force of some sprockets, gears or the like. Regarding the general purpose and the general and known features of a leader card, reference is made to the prior art references cited above, the disclosure of which is referred to in this application.

The leader card 12 additionally includes a cut-out 20 in which protrusions 16a, 16b are formed.

These protrusions 16a, 16b can, for example, be formed by means of punching, cutting with a knife or with a laser. Furthermore, it is possible to form the leader card together with all cut-outs, holes, of apertures or similar at once by means of molding, pressure molding or the like. Usually, the leader card is made of a plastic material, preferably by means of a plastic material, which is environmentally-friendly.

At the trailing end of the protrusions 16a, 16b, traction sections are provided traction sections 22, 24 which are brought into an overlapping position with respect to holes or apertures in the leading end of the film 30. These holes or apertures 26a, 26b in the leading end of the film can be created by punching, cutting or the like.

The protrusions are spaced apart at their leading ends which are connected to the leader card 12, while their trailing ends are formed close together, only being separated by a slot 32 which is very narrow so that the protrusions support each other at their trailing end in the direction perpendicular to the transport direction of the leader card 12 and the film 30.

Accordingly, if the traction sections 22, 24 are introduced into the apertures 26a, 26b at the leading end of the film 30, a traction force presses the trailing ends, and thus the traction sections 22, 24, of the protrusions 16a, 16b together by acting on the traction sections 22, 24. Accordingly, when a traction force acts on the leader card 12, the connection between the traction sections 22, 24 of the protrusions 16a, 16b and the edges of the apertures 26a, 26b in the leading end of the film makes the connection more reliable and more effective within the limits of the strength of the materials of the leader card and the film.

Accordingly, if the material of the film 30 is not resistant enough to withstand the traction forces and would be damaged by the traction sections of the leader card both, it is possible to strengthen the leading end of the film by adhering a strengthening strip to the leading end of the film 30, which is then provided with the apertures 26a, 26b together with the leading end of the film 30. For instance, the 135 mm film often needs to be strengthened to be able to withstand the traction forces, while the usual APS films need not be provided with the overlapping material strip at the leading end. The material strip (not specified) can also be fabricated of a plastic material.

It has to be noted that the cut-out 20 can be open at the trailing end of the leader card 12. This means that, although FIG. 1 shows that the cut-out is an opening or a coupling hole 20 formed in the leader card body of the leader card 12, is also possible to form the protrusions 16a, 16b in a cut-out which is open to the trailing end of the leader card 12.

According to the embodiment disclosed in FIG. 1, at the trailing end of the leader card 12 there is provided an insertion aperture or hole 18 between the trailing end of the leader card 12 and the trailing end of the coupling hole 20. This insertion hole 18 is used to introduce the leading end of the film 30 and to guide the leading end of the film 30, provided with the apertures 26a, 26b to be connected to the traction section 22, 24 of the protrusions 16a, 16b.

The insertion hole 18 may help to prevent bending of the film 30 with respect to the protrusion 16a, 16b. This helps to avoid any forces being created which could weaken the connection between the traction sections 22, 24 and the edges of the holes 26a, 26b of the leading end of the film 30. Additionally, the insertion hole helps to guide the film 30 in defined manner to be brought into contact and into a hooked relationship. Between the insertion hole 18 and the coupling hole 20, there is a bridge member 28b separating the coupling hole 20 from the insertion hole 18. At the trailing end of the insertion hole 18, there is further a bridge member 28a which supports the film end and holds the film at its end in the same plane as the leader card body of the leader card 12 during traction operation and during conveyance. This additionally helps to make the connection between the leader card 12 and the film 30 more reliable so that it is not possible that the contact between the leader card 12 and the film 30 can be weakened.

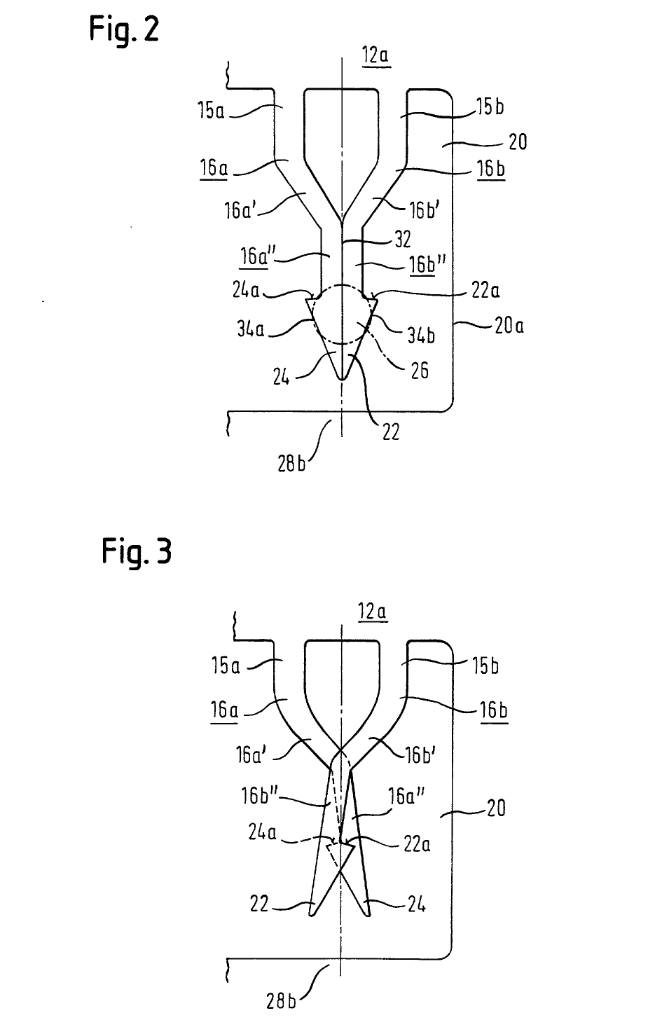

Now the function and the structure of the protrusion 16a, 16b will be discussed in greater detail with reference to FIGS. 2 and 3. According to FIG. 2, the protrusions 16a, 16b extend from the leader card body 12a in counter direction with respect to the transport direction. The coupling hole 20 is formed as an aperture in a trailing end of the leader card, but the coupling hole 20 may also be a cut-out if the coupling hole 20 terminates at approximately the location 20a. In this case, the bridge portion 28b would be non-existent. Since, however, the existence of the insertion hole 18 and the bridge portions 28a, 28b strengthening the connection between the leader card 12 and the film 30, it is a preferred embodiment according to the invention, if the insertion hole 18, shown in FIG. 1, is provided.

The protrusion 16a, 16b have base portions 15a, 15b which are connected to the leader card body 12a. These base portions 15a, 15b are spaced apart from each other and are relatively rigid, while spring portions 16a′, 16b′ are inclined with respect to the base portions 15a, 15b and from a weaker part of the protrusions 16a, 16b so that the protrusions 16a, 16b can be deformed particularly at these spring portions 16a′, 16b′. From the spring portions 16a′, 16b′ connecting portions 16a″, 16b″ extend in the counter direction with respect to the transport direction. At the end of the connection portions 16a″, 16b″, the traction sections 22, 24 are arranged. The traction sections 22, 24 are formed with shoulder sections 22a, 24a which can be brought in an overlapping relationship with respect to the edge of the hole 26, which is depicted here symbolizing the corresponding hole at the leading end of the film 30 shown in FIG. 1.

At the trailing ends of the traction sections 22, 24, there are provided guide edges 34a, 34b, which are formed to support the coupling operation between the protrusions and the holes in the leading end of the film, i.e. between the film and the leader card. However, these guide edges 34a, 34b are not very decisive for the coupling operation and may also be formed differently. For instance, it is also possible to have a circular shaped or wide angle shaped end portion, which, in principle, would not be helpful to support the coupling operation.

However, in accordance with FIG. 3, it is possible to deform a protrusion 16a, 16b such that the trailing end of the protrusions 16a, 16b and thus the traction sections 22, 24 overlap so that their dimensions in the direction perpendicular to the transport direction is about the same or smaller than the diameter of the holes or apertures 26, 26a, 26b in the leading end of the film. Accordingly, it is possible to introduce the protrusions to the hole or the holes in the leading end of the film 30.

As can be seen in FIG. 3, the protrusions 16a, 16b are mainly deformed in the case of the spring portion 16a′, 16b′, which tend to be deformed if a force is acting on the protrusions in the direction perpendicular to the transport direction of the arrangement 10 according to FIG. 1.

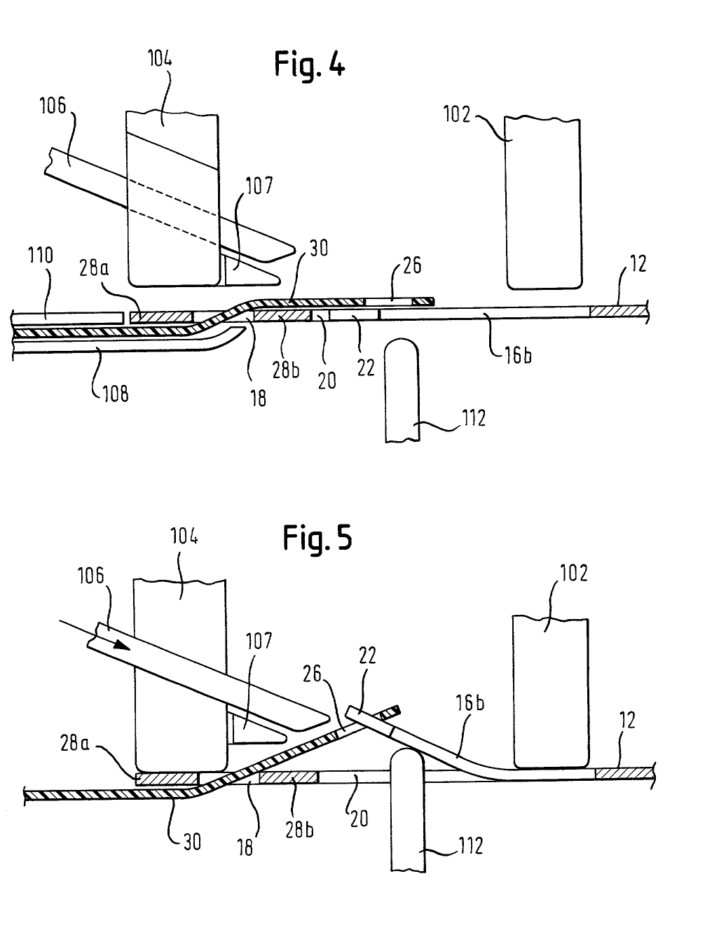

In FIG. 4, a first embodiment of an attaching device is illustrated. The attaching device is provided with upper support members 102, 104, which can be lowered and raised to press the leader card 12 against a base plate (not mentioned) to hold the leader in a defined position so as to introduce the film 30 to be connected to the leader card 12. The attaching device of FIG. 4 also includes deflecting means 112, 106, which are used to deflect or bend the protrusions 16a, 16b introduced into the aperture 26 at the leading end of the film 30. The deflecting means 106 can be moved in a guide channel in the second device 104 of the holding device 104, 102. The deflecting means 106 is also supported by a support and guide extension 107, which supports and holds the leading end of the film 30 in a defined position also during the coupling operation between the film 30 and the protrusions 16a, 16b of the leader card 12. The film 30 is introduced through the insertion hole 18 in the leader card 12 by means of guide plates 110, 108 so that in principle it is not necessary to deform or bend the ridge portions 28a, 28b of the leader card 12 according to this embodiment shown in FIGS. 4 to 7.

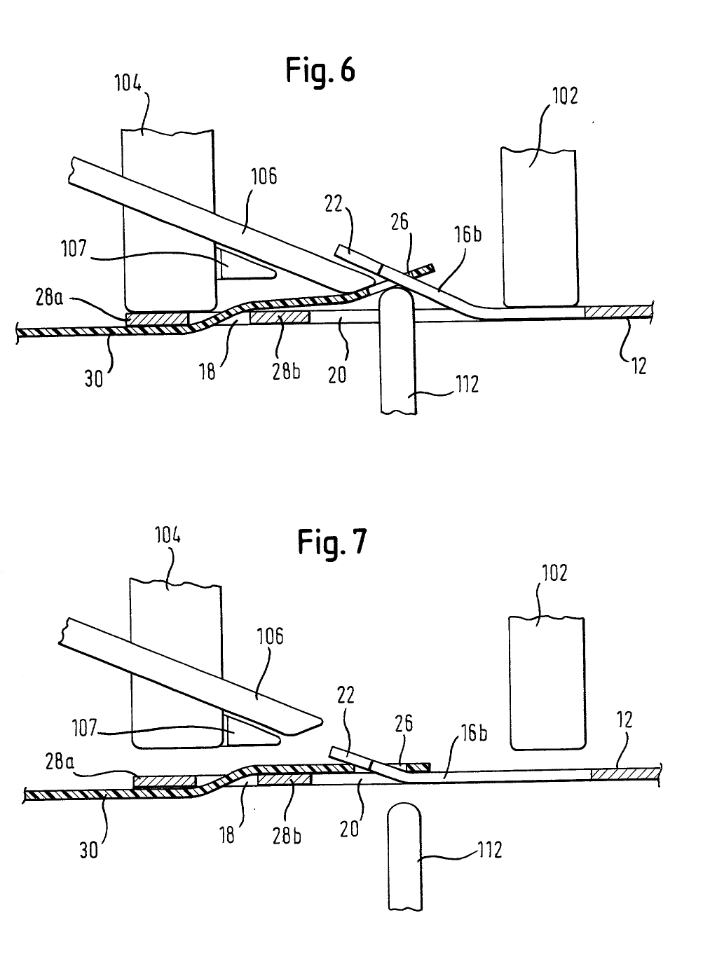

It is necessary according to this embodiment that the apertures 26 of the film 30 are arranged in a well defined position above the traction sections 22, 24 of the protrusions 16a, 16b. If the trailing end of the protrusions 16a, 16b is in a well defined position beneath the aperture 26 in the film 30, in accordance with FIG. 5, it is possible to raise the lifting dye 112 to bring the protrusions 16a, 16b in an inclined position with respect to the plane of the leader card 12. In this position, the protrusions 16a, 16b automatically also lift the leading end of the film, thereby bringing the traction sections 22, 24 in a position with respect to the apertures 26 such that the tips of the traction sections are automatically introduced into the apertures 26. In this situation, the pushing means 106 is lowered and, as shown in FIG. 6, is pressed on the film end beneath the tip of the traction sections 22, 24. Furthermore, the guide surfaces 34a, 34b, shown in FIG. 2, are effected by the edge of the aperture 26 so that the traction sections 22, 24 are deformed so that they can be introduced in the aperture 26.

To securely hold the leader card 12 in a defined position, in accordance with FIGS. 5 and 6. the support members 102, 104 of the holding means are lowered.

Although the guide plates 108, 110 shown in FIG. 4 are still present, they are not illustrated in FIGS. 5 to 7.

After the traction sections 22, 24 have been introduced in the aperture 26 in the leading end of the film 30, they return to their original shape as shown in FIG. 1, so that the shoulder portions 22a, 24a of the traction sections 22, 24 overlap with the edge of the aperture 26. In this position of the trailing ends of the protrusions 16a, 16b, the protrusions are supported or backed and stiffened by each other and support each other along the slot 32 which is extended between the protrusions 16a, 16b.

After the connecting operation has been terminated, the pressing members 102, 104 of the holding means, as well as the pushing members 106, 112 of the deflecting means, are withdrawn to an inactive position, and the leader card 12 together with the attached film 30 can be transported in the counter direction to the extension of the protrusions 16a, 16b.

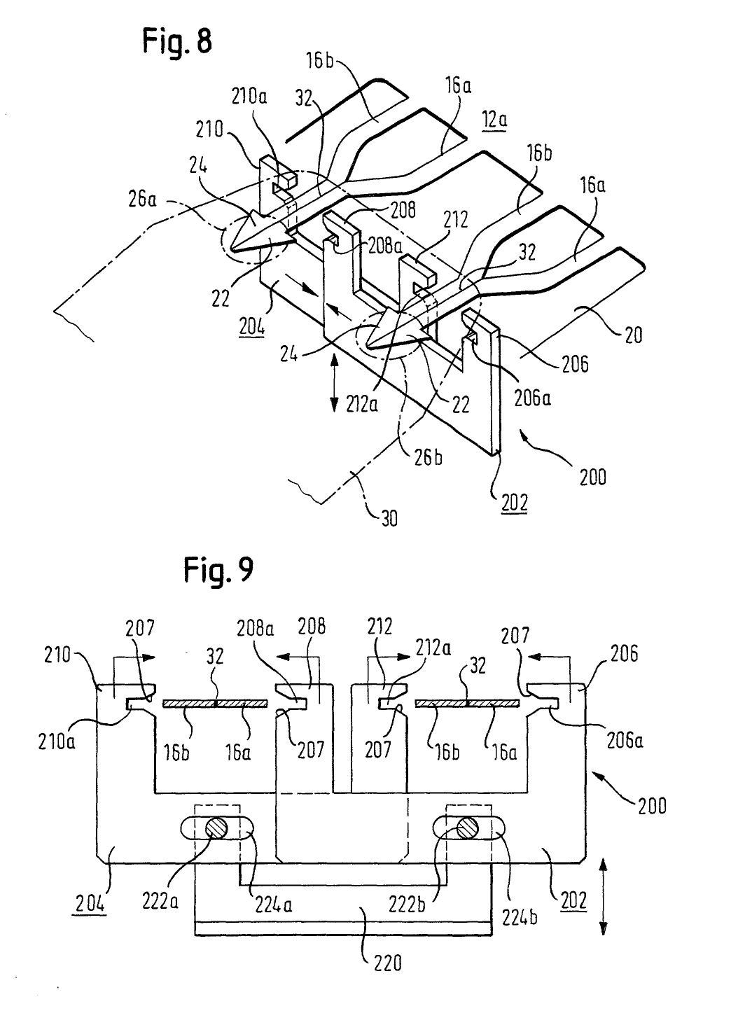

FIG. 8 depicts a further attaching device 200 in accordance with the present invention. The device 200 is also shown in more detail in FIG. 9.

The attaching device includes two pressing members 202, 204, which can be moved perpendicular to the transport direction in which the film 30 and the leader card 12 can be transported.

Additionally, the pressing members 202, 204 can be raised and lowered by means of a lifting device 220. Accordingly, the pressing members can be raised into the coupling hole 20 to act on the protrusions 16a, 16b, which have to be pressed together so that the traction sections 22, 24 can be introduced in the openings 26a, 26b. Each of the pressing members 202, 204 includes a pair of pressing jaws 206, 208 and 210, 212. The pressing jaws are provided with gripping cut-outs 210a, 208a, 206a, 212a to grip the protrusions 16a, 16b after the pressing members 202, 204 have been lifted to be extended into the coupling hole 20. The pressing members 202 and 204 are moved in counter directions with respect to each other so that the pressing jaws 208 of the pressing member 202 and the pressing jaws 210 of the pressing member 204 act on the protrusions 16a, 16b to deform these protrusions such that the traction sections 22, 24 overlap each other and are narrower than the diameter of the hole 26a in the leading end of the film 30.

The same is true for the deforming and introducing operation for the protrusions 16a, 16b which are located between the pressing jaws 206, 212 of the pressing members 202, 204.

During the pressing operation the connecting portions 16a″, 16b″ (see FIG. 2) are received in the recesses 206a, 212a, 208a, 210a.

After the introducing operation the pressing jaws are moved back to their inactive position in which the pressing members 202, 204 can be withdrawn, i.e. lowered to a position beneath the leader card body 12a.

As can be seen in FIG. 9, the recesses 206a, 208a, 210a, 212a have inclined guide sections 207, which are useful to guide the protrusions into the recesses 206a, 212a, 208a, 210a.

Since the protrusions 16a, 16b have to be bent into an overlapping position to narrow the outer distance between the traction sections, it is advantageous to form the guide surfaces as well as the recesses of the pressing jaws 206, 212 and 208, 210 at different heights so that, at the final positions of the protrusions in the corresponding recesses, the protrusions are no longer supported by the opposite protrusion at the slots 32.

As depicted in FIG. 9, the two pressing members 202, 204 are fixed to a lifting arrangement 220 by means of two bolts 222a, 222b. The bolts 222a, 222b are supported by guide groves 224a, 224b in the vertical direction and in the horizontal direction the bolts or pins 222a, 222b are movable in the guide groves, i.e. said pressing members 202, 204 are movable with respect to the bolts or pins 222a, 222b for conducting the pressing operation with respect to the protrusions 16a, 16b as well as the traction sections 22, 24. Furthermore, the guide groves 224a, 224b define the limits between which the pressing members as well as the pressing jaws 206, 208, 210, 212, are movable with respect to the protrusions 16a, 16b.

Of course, the attaching device according to FIGS. 8 and 9 can also be used for detaching the film from the leader card. In this case, the pressing members 202 and 204 are again lifted to be extended through the coupling hole 20 in the leader card body 12a, the movements of the pressing jaws 206, 208, 210, 212 being about the same. The film can be withdrawn from the leader card after the protrusions and the corresponding traction sections 22, 24 have been pressed together so as to be narrower than the diameter of the holes or apertures 26a, 26b in the leading end of the film.

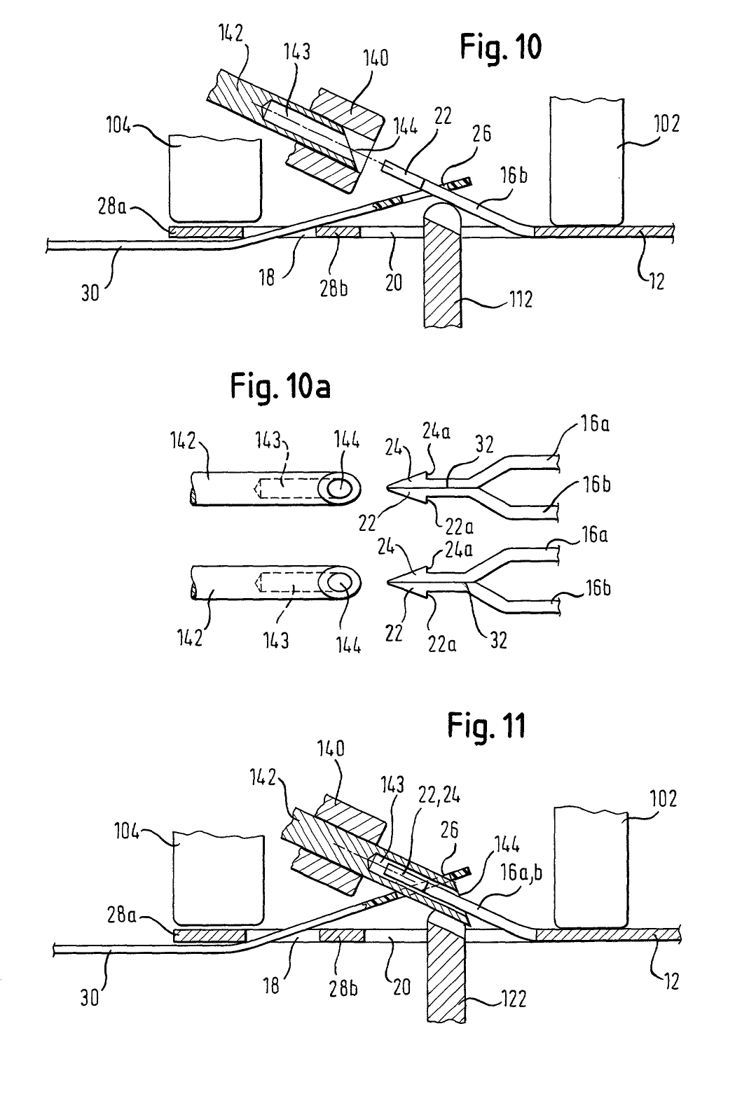

In the FIGS. 10, 10a and 11 a further detaching device is revealed.

A stamp or die 112 presses the protrusions 16a, 16b into an inclined position with respect to the plane of the leader card 12. In this position, a cannular is ejected from a cannular guide member 140. The cannular 144 includes a recess which is of circular cross section. The tip of the protrusions 16a, 16b is caught and received by the recess 143 of the cannular 142. The tip of the cannular 142 is shaped tilted to broaden the surface of the opening 144 and to facilitate catching the tip of the protrusions 16a, 16b. When the tip with the traction sections 22, 24 is in the inclined or sloped position and the cannular 142 is ejected, the opening 144 of the cannular catches the tip of the protrusions 16a, 16b and, within the recess 143, the protrusions are shifted together. Furthermore, as shown in FIG. 11, the traction sections are pushed out of the openings 26 in the leading end of the film 30. In this situation, it is possible to withdraw the film or to convey the leader card so that the leader card 12 and the film 30 are separated.

Of course, according to all of the embodiments set forth here it is possible to repeatedly use the leader card 12 since the leader card is not destroyed during the attaching and detaching operations.

As shown in FIG. 10a, if several protrusions 16a, 16b are formed at the trailing end of the leader card, several of the cannulars 142 can be used to perform the same operation.

In principle, also this kind of detaching mechanism can be used for attaching a leader card to a film. If the attaching operation is to be carried out has to be done, the cannulars or cannular 142 is to be introduced first through a hole 26 in the leading end of the film 30 and, afterwards, the cannular covers the traction sections 22, 24 of the protrusion 16a, 16b so that the traction sections 22, 24 becomes narrower than the diameter of the hole or aperture 26 in the film. Subsequently, the protrusions 16a, 16b, together with their associated traction sections 22, 24, can be drawn or shifted through the hole 26.

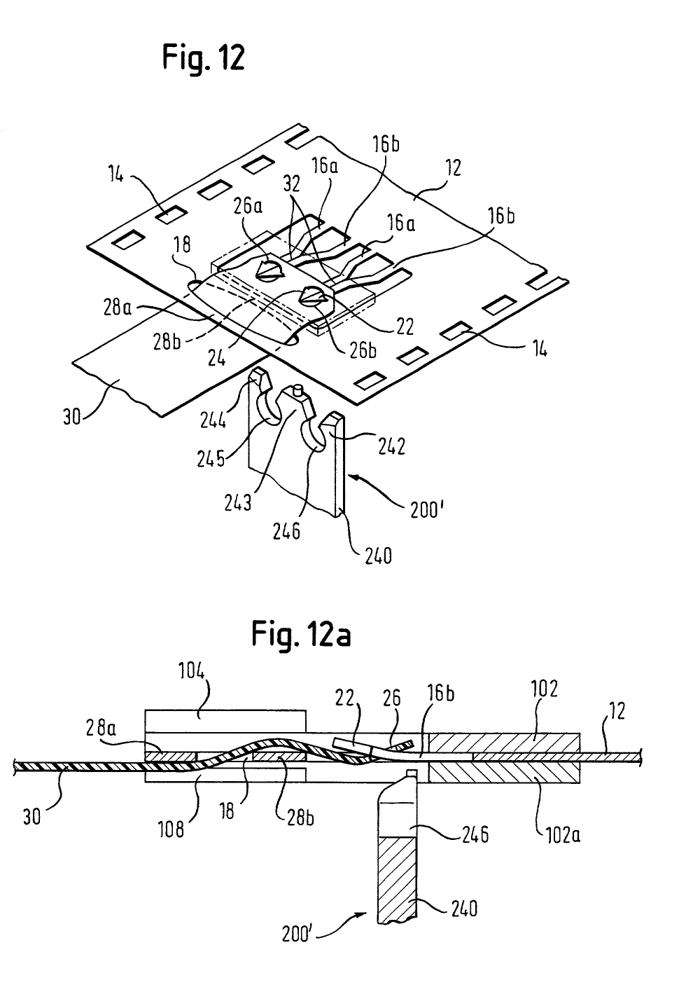

The FIGS. 12 and 12a show another preferred embodiment of the present invention. The film detacher according the FIGS. 12 and 12a, in principle, works like the detaching device according to FIGS. 8 and 9. However, the liftable detaching die 200′ according to this embodiment only shifts together the protrusions 16a, 16b by means of guide surfaces 245, 246 of prongs 244, 243, 242 of the ejector or stamp die 240 of the detaching device 200′. When the stamp or ejector die is lifted, the protrusions are moved together shift together so that the traction sections 22, 24 become narrower. The film can now be withdrawn from the traction sections passing the edges of the hole or aperture 26 in the leading end of the film 30. During this operation, the protrusions 16a, 16b are supported by support plates 102, 102a and by a support or holding member 104 and a guide plate 108. The guide plate 108 again has a guide channel so that it is possible to withdraw the film 30 while the holding means and the pressure plates are in their support position.

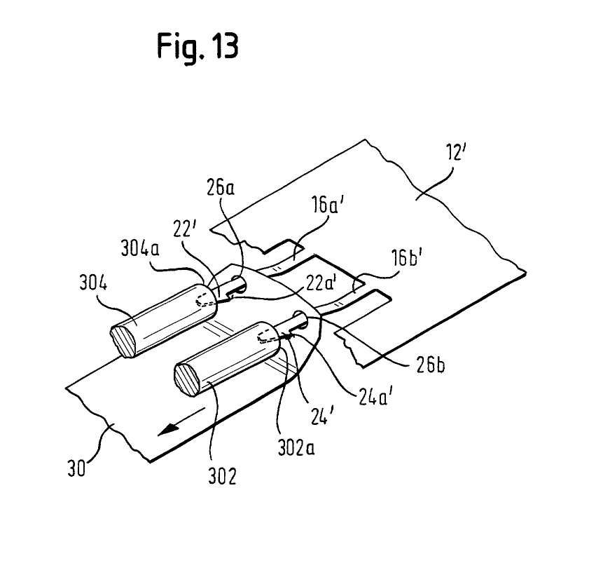

The FIGS. 13 to 15 show a further detaching device according to the invention, which is used to detach another kind of leader card 12′ from the leading end of a film 30.

According to FIG. 13, the protrusions 16a′, 16b′ are spaced apart from each other. Traction sections 22′, 24′ each have a dimension in the direction perpendicular to the traction direction which is about the same as the diameter of the holes 26a, 26b in the leading end of the film. The protrusions 16a′, 16b′ are shaped such that, again, an overlapping area of the traction sections 22′, 24′ can be hooked to the edge of the holes 26a, 26b in the leading end of the film 30 and such that between the two protrusions 16a′, 16b′ there is a narrowing distance or a widening distance. In FIG. 13, the distance towards the tips and the traction sections 22′, 24′ of the protrusions 16a′, 16b′ becomes narrower.

The protrusions 16a′, 16b′ can be moved together or can be rotated to come to a position where the traction sections are withdrawable from the holes 26a, 26b in the leading end of the film 30.

According to the particular embodiment represented in FIGS. 13 to 15, the cannular shaped members 302, 304 are able to rotate the tips or traction sections 24′ such that they can be released from engagement with the edge of the hole 26 in the leading end of the film 30.

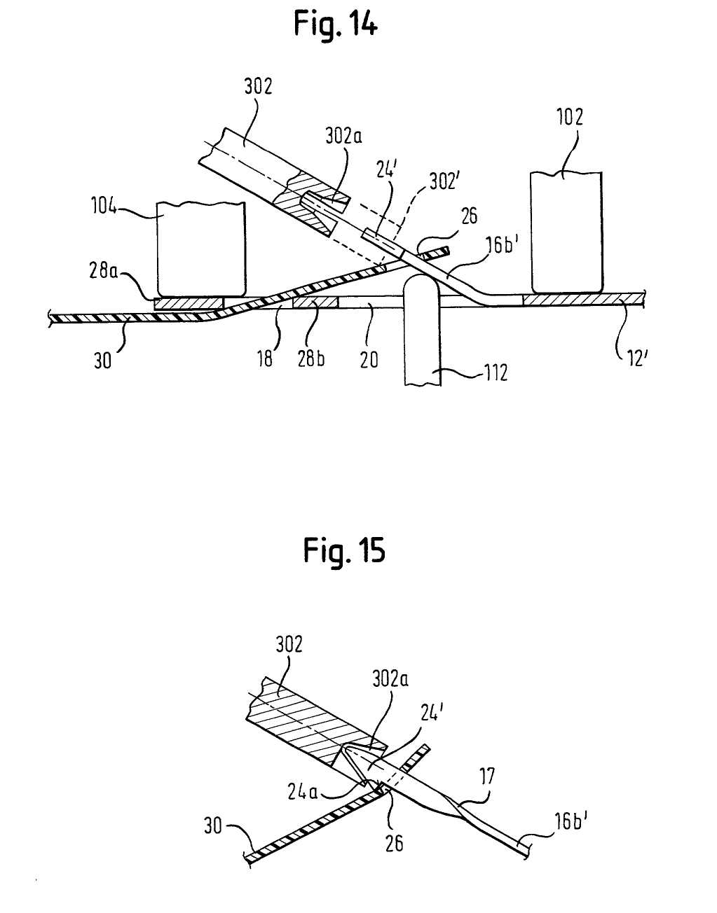

As can be seen in FIG. 14, the detaching member 302 is moved from an inactive position to an active position 302′ in which the tip or traction section 24′ is thread into a recess 302a in the tip of the detaching member 302. As can be seen in FIG. 15, the detaching member 302 is rotated and the protrusion 16b′ is deformed in a section 17 so that the traction section 24′ with its traction shoulder 24a′ can be pushed or drawn through the hole 26 in the leading end of the film 30.

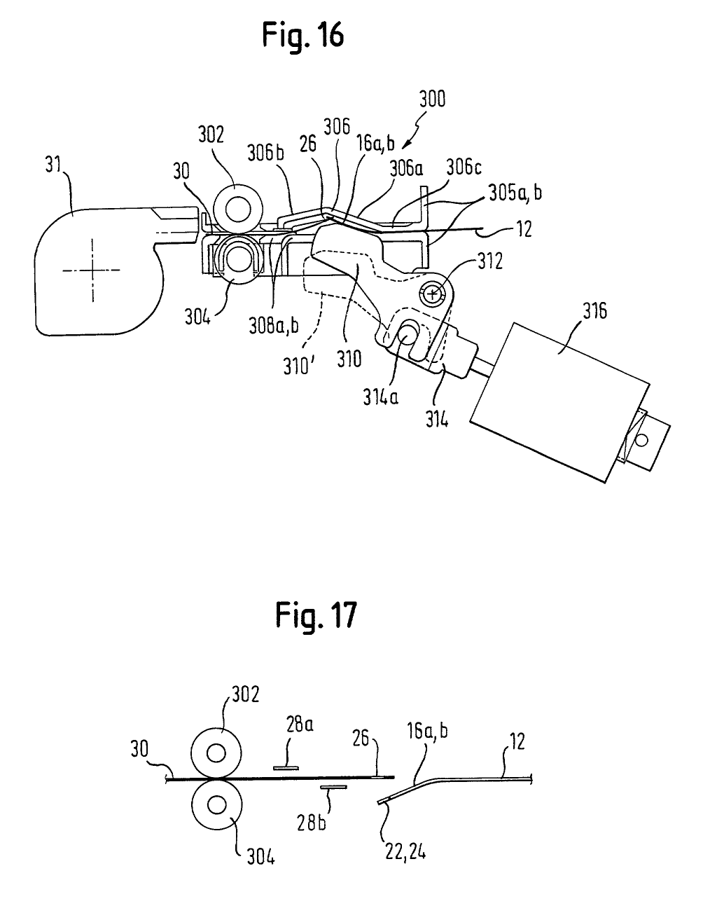

Shown in FIGS. 16 and 17 is another embodiment of an attaching device in accordance with the present invention.

In FIG. 16, a film cartridge 34 is attached to the entrance of an attaching device 300 which is in accordance with the present invention. The film 30 is withdrawn from the film cartridge 31 by means of traction rollers 302, 304. The film, which is provided with one or two holes, is guided between two guide members 308a, 308b to be introduced to a threading chamber 306. From the other end of the threading chamber 306, a leader cartridge 12 is introduced via leader cartridge guide plates 305a, b. In the threading chamber 306, the protrusions 16a, 16b of the leader cartridge 12 are bent in a direction tilted downwards from the plane of the leader cartridge 12 (see FIG. 17). Afterwards, a lever tool which, in the inactive position, is represented by the reference number 310′ is swiveled or rotated around a bolt 312 in an upward direction to bend or deform the protrusions 16a, 16b towards the leading end of the film 16 so that the tips of the protrusions 16a, 16b can be introduced in the holes 26 of the film. The guide surfaces 306a, 306b for the protrusions of the leader card and for the leading end of the film 30 limit the space for the movement of the film and of the leader card to be connected with each other. The part 306c of the guide surfaces of the thread channel 306 helps to bend the protrusions 16a, 16b downwards in the first moment before the lever die 310′, 310 is rotated upwards by means of an actuator 316, which is an electromagnetic actuator in this case. The actuation force is transmitted via an actuation rod 314 and a bolt connection 314a to the lever die 310.

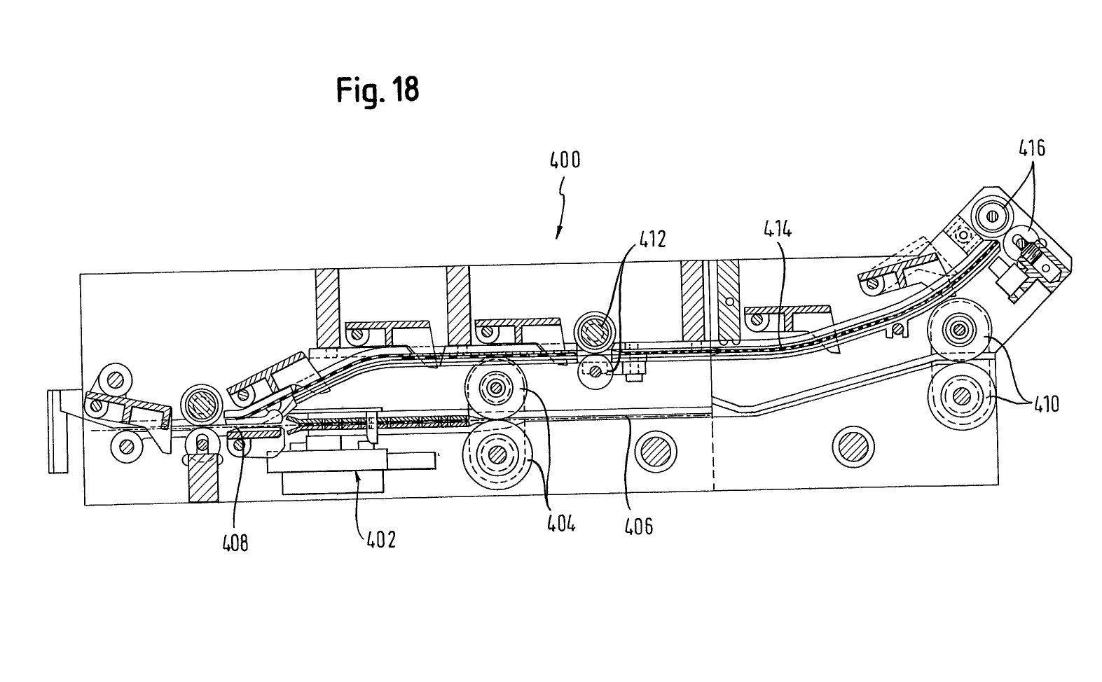

Finally, FIG. 18 depicts a detaching section in a minilab. The reference number 402 represents a detaching device in accordance with the present invention. In this device, the leader card is separated from the leading end of the film, and the separated leader card can be moved by means of the roller pairs 404, 410 to be used once again in an attaching device in accordance with the present invention. At the entrance section of the arrangement 400 according to the invention, there is provided a switch or selector arrangement which is able to direct the leader card, together with the film attached thereto to the detaching device 402. Subsequently, the detaching operation is performed and then the film end can be withdrawn so that the selector can change position to guide the film via a conveyor path 414, while the separated leader cartridge can be conveyed via a conveyor path 406. The conveyance of the film can also be accomplished by roller pairs 412, 416. From the last roller pair 416, the developed film can be introduced into an exposure device or a scanner device. Additionally, it is possible to introduce and reel up the film in a film cartridge.

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What we claim is:

1. A leader card for attachment to the leading end of a photographic film comprising a plane leader card body having several traction holes located along the longitudinal sides in transport direction of the leader card and of the film attached thereto, said leader card having a cut-out at the trailing end thereof and at least one protrusion to be brought into connection with the at least one aperture in the leading end of the film, the at least two protrusions are arranged at the leading end of the cut-out, the protrusions being extended in the counter direction with respect to the transport direction, wherein each of the protrusions are provided with a traction section dimensional to overlap with an edge of the aperture formed in the leading end of the film, each of the protrusions being deformable and/or deflectable.

2. A leader card according to claim 1, wherein in that said cut-out is a coupling hole, said coupling hole being provided at the trailing end of said leader card body.

3. A leader card according to claim 2, wherein an insertion hole in that located between the trailing end of the leader card body and the coupling hole is for inserting the leading end of the film to be lead to said coupling hole to be connected to the protrusions.

4. A leader card according to claim 1, wherein the protrusions are leg-shaped.

5. A leader card according to claim 1, wherein the protrusions are spaced apart from each other at least at their leading ends, which are connected to the leader card body.

6. A leader card according to claim 1, wherein the protrusions are formed such that their trailing ends are close together.

7. A leader card according to claim 1, wherein the said traction section or sections are at least roughly arrow-shaped or toughly shaped like to tip of an arrow.

8. A leader card according to claim 1, wherein the protrusions are arranged in pairs forming a particularly arrow-shaped traction section at their trailing ends.

9. A leader card according to claim 8, wherein at least two pairs of protrusions are formed.

10. A leader card according to claim 1, wherein the protrusions have a guide means at their trailing ends to guide a traction section or sections into the hole in the leading end of the film.

11. An attaching device for connecting a leading end of a photographic film with at least one hole to a leader card said attaching device including:
a holding device for holding said leader card in a particular position;
a transport device for transporting said film and/or said leader card in a transport direction;
a deflecting means for deflecting the protrusion or protrusions of the leader card and/or the film to guide the trailing ends of the protrusions with their traction sections into the hole or holes at the leading end of the film.

12. An attaching device according to claim 11, wherein said deflecting means are arranged such that the protrusions and/or a film are deformed or bent into an angled, tapered or a tilted position with respect to the plane of the leader card body.

13. An attaching device according to claim 11, wherein said holding device includes a base or top section having a guide track for the film for leading the film to a position to be attached to the protrusions of the leader card.

14. An attaching device according to claim 13, wherein said guide track is formed to lead said film through an insertion hole in the leader card body.

15. An attaching device according to claim 11, wherein the holding device includes an advancing portion for deforming the leader card in the vicinity of the insertion hole so that at least one of two bridge members of the insertion hole of the leader card is deformed to be out of the plane of the leader card, so that the photographic film can be moved through the insertion hole by moving the film and/or the leader card.

16. An attaching device according to claim 11, wherein an unloading compartment is arranged, said compartment being light tight or light proof connectable to the attaching device to unload a photographic film from a film cartridge, while said photographic film is still light sensitive.

17. An attaching device according to claim 16, wherein that two or more unloading compartments are arranged for supplying photographic films alternatively therefrom.

18. An attaching device according to claim 11, wherein first pressing or advancing means for pressing or advancing the protrusions of the leader card in a direction such that the protrusions with the traction sections can be more easily introduced in the holes in the leading end of the film.

19. An attaching device according to claim 11, wherein second pressing means for pressing the film in the direction towards the plane of the leader card.

20. A detaching device for separating a photographic film from a leader card comprising:
a detacher holding means for holding the leader card;
a detacher transport device for transporting the leader card and/or a film before and/or after a detaching operation;
a detacher deflecting means for deforming protrusions of the leader card such that traction sections are released from a hole or holes in the leading end of said photographic film.

21. A detaching device according to claim 20, wherein the detacher deflecting means are constructed such that the protrusions are deformed in the counter direction with respect to the extension direction of the traction section.

22. A detaching device according to claim 20, wherein the detacher transport device is controlled to move the film and/or the leader card after the deformation of the protrusions such that the film is detached from the leader card.

23. A detaching device according to claim 20, wherein the detacher deflecting device includes ejector means being ejectable into the plane of the leader card body, said ejector means having a forck-like shape with prongs being formed to be movable such that the protrusions are deformed to release the film.

24. A detaching device according to claim 20, wherein is a switch or selector construction with two guide tracks connected thereto being arranged downstream of the detacher deflecting means one of said guide tracks being for the transport of the film after separation from the cartridge and the other of the guide tracks being for the transport of the detached leader cartridge.
